(19) United States
(12) Patent Application Publication
(10) Pub. No.: US 2025/0151755 A1
(43) Pub. Date: May 15, 2025

(54) METHOD FOR MANUFACTURING SHRIMP FEED PELLETS

(71) Applicant: PURAC BIOCHEM B.V., Gorinchem (NL)

(72) Inventor: Cristian ATIENZA TORO, Gorinchem (NL)

(21) Appl. No.: 19/020,886

(22) Filed: Jan. 14, 2025

Related U.S. Application Data
(63) Continuation of application No. PCT/EP2023/068987, filed on Jul. 10, 2023.

(30) Foreign Application Priority Data
Jul. 15, 2022 (EP) 22185252.8

(51) Int. Cl. A23K 10/12; A01K 61/59; A23K 20/158; A23K 40/10; A23K 40/20; A23K 50/80

(52) U.S. Cl. CPC A23K 10/12; A01K 61/59; A23K 20/158; A23K 40/10; A23K 40/20; A23K 50/80

(57) ABSTRACT

The invention pertains to a process for manufacturing shrimp feed pellets with a bulk density of at least 550 g/l and a particle diameter of 0.25-5 mm comprising the steps of
providing a biomass product with a water content of at most 10 wt. % (calculated on the biomass product) and a DHA content of at least 20 wt. % (calculated on the biomass product), the biomass product being derived from microorganisms of the family Thraustochytriaceae or the family Cryptecondiniaceae,
preparing a mixture comprising 0.1-10 wt. % (calculated on dry weight of the shrimp feed pellet) of said biomass and the balance further feed components,
subjecting the mixture thus obtained to a pellet pressing step, to form shrimp feed pellets with a bulk density of at least 550 g/l and a particle diameter of 0.25-5 mm.

It has been found that the incorporation of the specified biomass product in the specified amount in the composition provided to a pellet press makes it possible to obtain shrimp feed pellets with desirable properties in a single step pelletising process. As compared to the addition of fish oil, the addition of biomass product to the composition for the pellet press results to lesser—or no—degradation of the DHA. It also does not result in excessive lubrication of the press.

The invention also pertains to shrimp feed pellets that can be obtained using the process of the present invention.

The present application is a continuation application of PCT/EP2023/068987 filed Jul. 10, 2023, which claims priority to EP 22185252.8 filed Jul. 15, 2022, the entire contents of both which are incorporated herein by reference.

The invention pertains to a method for manufacturing shrimp feed pellets, and to the shrimp feed pellets that can be obtained therewith.

In shrimp aquaculture, shrimp are provided with feed aimed to meet their nutritional needs. However, for shrimp to benefit from their feed to the best possible extent, in addition to their nutritional requirements, shrimp feed pellet need to meet a number of physical requirements. Shrimp are bottom feeders who consume their feed by nibbling from the pellets. This means that for the pellets to be accessible to the shrimp, they should not float but sink below the water surface relatively quickly after feeding. Further, because the shrimp will not feed from disintegrated pellets, the shrimp feed particles should have a relatively high stability in water, i.e., they should not disintegrate too quickly after feeding. Additionally, in view of the nibbling from the particles as discussed above, it is necessary that the particles have a homogeneous nutrient distribution, because otherwise feed nibbled from the core of a particle will have a different composition than feed nibbled from the particle outer layer. To allow homogeneous feeding of the particles over the shrimp feed basin, the particles of the shrimp feed should not be too large. A suitable particle size is 0.25-5 mm diameter. This relatively small particle size means that there is a relatively large outer pellet surface, which makes for an additional challenge when aiming for a pellet with a relatively high water stability.

In the art, shrimp feed pellets are often manufactured by extrusion or using a pellet press. While extrusion is a flexible and therewith attractive way of manufacturing feed pellets, it has the disadvantage of requiring substantial investment in apparatus and operating costs. A pellet press has the advantage of ease of operation and low capital investment. It has, however, been found that not all feed ingredients are easily compatible with pellet pressing.

One ingredient which often causes issues in the manufacture of shrimp feed meeting the required properties are unsaturated fatty acids such as DHA through fish oil. It has been found that when fish oil with a high DHA content is added to the composition provided to the pellet press, the DHA content in the final pellet is lower than the DHA content of the feed before pelletising, due to degradation of the DHA under the conditions prevailing in the manufacturing process, including preconditioning and pressing at elevated temperature and moisture content. An additional problem is that the addition of oil to the composition provided to the pellet press may lead to excessive lubrication of the press, which may result in clogging of the press, the formation of pellets with different sizes and shapes, pellet agglomeration, and insufficient blend homogeneity.

This problem is often solved by the inclusion of a low-quality fish oil to the feed to be pelletised, and post-impregnation of oil with a higher DHA content. This process has a number of disadvantages, however. In the first place, it requires an additional processing step, with associated additional costs for apparatus and operation. In the second place there is a risk that the oil with a higher DHA content is not homogeneously distributed in the resulting pellets, resulting in inhomogeneous feeding of the shrimp. Further, impregnation of pellet-pressed particles, especially relatively high-density pellet-pressed particles as required to obtain the necessary sinking behaviour, is often incomplete, resulting in oil being present on the outside of the particles. This in turn, may lead to pellet agglomeration and may affect the storage properties of the shrimp feed.

There is need in the art for a method for manufacturing shrimp feed pellets though a pellet pressing process which results in shrimp feed particles with desirable nutritional and physical properties, which do not suffer from the disadvantages of the known processes. The present invention provides such a process.

The invention pertains to a process for manufacturing shrimp feed pellets with a bulk density of at least 550 g/l and a particle diameter of 0.25-5 mm comprising the steps of
providing a biomass product with a water content of at most 10 wt. % (calculated on the biomass product) and a DHA content of at least 20 wt. % (calculated on the biomass product), the biomass product being derived from microorganisms of the family Thraustochytriaceae or the family Cryptecondiniaceae,
preparing a mixture comprising 0.1-10 wt. % (calculated on dry weight of the shrimp feed pellet) of said biomass and the balance further feed components,
subjecting the mixture thus obtained to a pellet pressing step, to form shrimp feed pellets with a bulk density of at least 550 g/l and a particle diameter of 0.25-5 mm.

It has been found that the incorporation of a biomass product as specified above in the specified amount in the composition provided to a pellet press makes it possible to obtain shrimp feed pellets with desirable properties in a single step pelletising process. As compared to the addition of fish oil, the addition of biomass product to the composition for the pellet press results to lesser—or no—degradation of the DHA. It also does not result in excessive lubrication of the press.

The invention also pertains to shrimp feed pellets that can be obtained using the process of the present invention.

Accordingly, the present invention also pertains to pellet-pressed shrimp feed pellets with a bulk density of at least 550 g/l and a particle diameter of 0.25-5 mm, comprising 0.1-10 wt. % (calculated on dry weight of the shrimp feed pellet) of biomass product with a water content of at most 10 wt. % (calculated on the biomass) and a DHA content of at least 20 wt. % (calculated on the biomass), the biomass being derived from microorganisms of the family Thraustochytriaceae or the family Cryptecondiniaceae.

The invention, its specific embodiments, and further advantages thereof, will be discussed in more detail below.

The present invention makes use of a biomass product with a water content of at most 10 wt. % (calculated on the biomass product) and a DHA content of at least 20 wt. % (calculated on the biomass product), the biomass product being derived from microorganisms of the family Thraustochytriaceae or the family Cryptecondiniaceae.

The biomass is derived from microorganisms of the family Thraustochytriaceae or the family Crypthecodiniaceae. Microorganisms of the family Thrausochytriaceae are preferably from the genus Schizochytrium (such as S. aggregatum), Thraustochytrium (such as T. aggregatum, T. multirudimentale, and T. striatum), Aurantiochytrium (such as A. limacinum and A. mangrovei), or Ulkenia (such as U. visurgensis and U. amoeboidea). Microorganisms of the family the family Crypthecodiniaceae are preferably from the genus Crypthecodinium. In one embodiment, Schizochytrium limacinum or Aurantiochytrium limacinum is used.

Within the context of the present specification a biomass product is a dried biomass. Dried biomass may, e.g., be obtained by subjecting a fermentation medium comprising microorganisms of the families Thraustochytriaceae or Cryptecondiniaceae to a drying step, e.g., a spray-drying step.

The biomass product used in the present invention has a water content of at most 10 wt. %. A too high water content will detrimentally affect the manufacturing process, the physical properties of the pellets obtained by the process, and the properties of the pellets, including their storage stability. The water content of the biomass product preferably is less than 8 wt. %, in particular less than 6 wt. %, more in particular less than 4 wt. %, still more in particular less than 2 wt. %, in some embodiments less than 1 wt. %.

The water content is determined via Karl Fischer titration. The Karl Fischer procedure is a volumetric titration process used for the quantitative determination of water content in liquid and solid samples. The titration is carried out with titrant Hydranal Composite 2 (a one-component reagent which already contains all the reactants including iodine, sulfur dioxide, and the bases imidazole and 2-methylimidazole). Titration medium used is a mixture of dried dichloromethane (DCM) and dried methanol (ratio 75/25% v/v) The endpoint is determined using bivoltametric indication. i.e. the potential at the polarized double-platinum-pin electrode falls below a certain value, e.g., for a Mettler Toledo V30 KF Titrator with DM143-SC electrode and polarization current setting of 24.0 μA, the value is 100.0 mV.

The water content in the sample can be determined by the added amount of the reagent.

The biomass product has a DHA content of at least 20 wt. %.

The dried biomass may, e.g., contain at least 25 wt. % DHA, at least 30 wt. % DHA, at least 35 wt. % DHA, at least 40 wt. % DHA, at least 45 wt. % DHA or optionally between 20 wt. % and 50 wt. % DHA, or between 20 wt. % and 45 wt. % DHA, or between 25 wt. % and 35 wt. % DHA, or between 25 wt. % and 45 wt. % DHA of the dry biomass weight.

In the process according to the invention, the biomass product is incorporated into shrimp feed pellets in an amount of 0.1-10 wt. %, calculated on the dry weight of the shrimp feed pellets.

If the amount of biomass product is too low, the beneficial effect of the addition of the biomass product on the feed processing will not be obtained, and neither will the effect of adding DHA to the shrimp feed. It may be preferred for the biomass product to be incorporated into the shrimp feed pellets in an amount of at least 0.3 wt. %, in particular at least 0.5 wt. %, in some embodiments at least 1.0 wt. If the amount of biomass product is too high, excessive lubrication may occur during processing, and the amount of DHA-containing biomass in the feed may be so high that there is insufficient room for the other components of the shrimp feed. It may be preferred for the biomass product to be incorporated into the shrimp feed pellets in an amount of at most 8 wt. %, in particular at most 6 wt. %, in some embodiments at most 5 wt. %, at most 3 wt. %, or at most 2 wt. %. A range of 0.5-2 wt. % may be mentioned as preferred.

From a nutritional point of view the shrimp feed pellets will generally comprise the following, calculated on dry weight of the pellets:
protein, generally in an amount of 30-50 wt. %
carbohydrates, generally in an amount of 5-40 wt. %
lipids, generally in an amount of 5-15 wt. %
ash, generally in an amount of 3-15 wt. %

The feed generally has an energy content in the range of 250-450 Kcal/100 g feed.

Suitable components to provide the various nutritional elements are known in the of shrimp feed manufacture, and require no further elucidation here. They include, for example, plant products such as vegetable oils, soybean meal, cornmeal, corn gluten, and other plant products, animal products such as beef tallow and poultry products, fish meal and fish oil.

In the process according to the invention, the various feed components, including the biomass product, are combined to form a mixture, and the mixture is subjected to a pellet pressing step to form shrimp feed pellets with a bulk density of at least 550 g/l and a particle diameter of 0.25-5 mm.

Pellet pressing is known in the manufacture of shrimp feed. The general process is described below.

In a first step a mixture is prepared comprising the various feed ingredients. A grinding step maybe present to ensure a desired particle size of the various ingredients. Water or other liquid may be added to arrive at a pelletable mixture. which is often indicated as mash. The pelletable mixture or mash is generally subjected to a preconditioning step. In preconditioning the pelletable mixture is kept for a temperature of 1-10 minutes, e.g., 1-3 minutes, at temperatures above 70° C., e.g., 80-98° C. or 85-95° C., at a desired moisture content. Moisture may be in the form of liquid added to the feed, of steam, or both.

Preconditioning is carried out for various reasons, including cooking of the feed ingredients to improve digestibility and binding properties of feed components, ensuring a moisture content at which pelleting can be carried out. Preconditioning often takes place under mixing, which means that the mixing step and the preconditioning step can be combined.

The preconditioned feed mixture is then provided to the pellet press, where it is converted into pellets. Pellet pressing generally takes place at a temperature of 50-100° C., in particular 60-100° C., e.g., 70-90° C. The pelletised product is then cooled to room temperature.

The moisture content of the final shrimp feed pellets generally is in the range of 0-25 wt. %, in particular 0-15 wt. %, more in particular 5-10 wt. %. A drying step may be carried out if so desired.

The pellet pressing step yields the shrimp feed pellets. There post impregnation or coating with other shrimp feed components is possible, but generally not required.

The invention also pertains to the shrimp feed pellets which can be obtained by the process according to the invention.

Accordingly, the present invention also pertains to pellet-pressed shrimp feed pellets with a bulk density of at least 550 g/l and a particle diameter of 0.25-5 mm, comprising 0.5-10 wt. % (calculated on dry weight of the shrimp feed pellet) of biomass product with a water content of at most 10 wt. % (calculated on the biomass) and a DHA content of at least 20 wt. % (calculated on the biomass), the biomass being derived from microorganisms of the family Thraustochytriaceae or the family Cryptecondiniaceae.

The bulk density of the pellets is defined as the dry weight of a volume of pellets divided by the weight of the pellets, determined in a 1-liter volume.

The bulk density of shrimp feed pellets according to the invention is at least 550 g/l. If the bulk density is below that value, the sinking behaviour of the particles is not adequate. It is preferred for the bulk density to be at least 600 g/l, in some embodiments at least 650 g/liter. In general, the bulk density is at most 1000 g/l, in particular at most 900 g/ml, more in particular at most 800 g/ml. The bulk density is necessary to have the desired sinking behaviour. As indicated above, shrimp are bottom feeders, and fast sinking of the pellets is required to ensure that the feed reaches the shrimp as quickly as possible.

The shrimp feed pellets according to the invention have a particle diameter of 0.25-5 mm. The particle diameter is the diameter of the particle over its longest axis. The particle may have any shape as can be manufactured through pellet pressing. Examples of suitable shapes are cylinders, spheres, tablets, and rods, with cylinders being preferred. In one embodiment the pellets have a height to diameter range of 1:5 to 5:1, in particular 1:3 to 3:1, more in particular 1:2 to 2:1.

One feature of the shrimp pellet feed according to the invention is that the biomass product, and in particular the DHA present therein, is distributed homogeneously through the pellet. This means that shrimp feeding from the pellets will ingest the same percentage of DHA, irrespective of whether they feed from the pellet core or from the pellet surface. This in turn leads to a more homogeneous shrimp quality.

This parameter may be quantified as follows: the ratio between the DHA content in a sample taken from the core of the pellet and the DHA content in a sample taken from the outer layer of the pellet is between 0.8:1 and 1:0.8, in particular between 0.9:1 and 1:0.9.

The shrimp feed pellets of the present invention generally has a pellet durability index, also indicated as PDI or Holmen pellet durability test of at least 80%, more in particular at least 85%, still more in particular at least 90%. The Holmen durability test mimics the degradation that pellets experience during transport and handling. Determination of this parameter is known to the skilled person.

The invention also pertains to a process for growing shrimp characterised by feeding the shrimp with the shrimp feed pellets of the present invention.

As will be evident to the skilled person, different embodiments of the present invention can be combined unless they are mutually exclusive. Preferences discussed in the context of the product also apply to the process and vice versa.

All percentages used herein are weight percentages, unless specified otherwise. When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

The invention is illustrated by the following examples without being limited thereto or thereby.

### EXAMPLE 1: DHA STABILITY IN PELLET PRESSED PARTICLES

Feed ingredients including DHA-containing biomass were combined to form a feed mixture. The DHA-containing biomass was dried biomass of the species Schizochytrium with a water content of less than 1 wt. % and a DHA content of 33 wt. %. The DHA-containing biomass was incorporated into the feed composition in amounts of, respectively, 1 wt. %, 2 wt. %, 3 wt. %, or 5 wt. %. The DHA content in the feed was respectively 0.3, 0.6, 0.9, and 1.5 wt. %. The feed compositions were brought to a temperature of 75° C. in 80 seconds and 90° C. in 110 seconds in a feed preconditioner (time from room temperature). The fatty acid profile in the feed was determined using gas chromatography with flame ionisation. It appeared that for all samples the amount of DHA in the sample after the preconditioning step was the same as that before the preconditioning step. No degradation was observed. This is in contrast with the situation where DHA-containing fish oil is used, which is known to degrade under preconditioning.

### EXAMPLE 2: DHA STABILITY IN PELLET PRESSED PARTICLES-RETENTION TIME

DHA stability was determined in a batch preconditioner with 20 kg ground feed ingredients, including biomass as described in Example 1. Three experiments were carried out, with biomass inclusions of 1 wt. %, 3 wt. % and 5 wt. %, respectively. The batches were conditioned at 90° C. and samples were taken after 1 minute, after 3 minutes and after 5 minutes and DHA contents were determined. The results are presented in the following table:

| | 1 wt. % | 3 wt. % | 5 wt. % |
|---|---|---|---|
| | biomass | biomass | biomass |
| DHA content at t = 1 minute (wt. %) | 0.3 | 0.9 | 1.5 |
| DHA content at t = 3 minutes (wt. %) | 0.3 | 0.8 | 1.5 |
| DHA content at t = 5 minutes (wt. %) | 0.2 | n.d. | 1.3 |

*not determined

It can be seen that after conditioning for 1, 3 or 5 minutes at 90° C. the degradation of DHA is quite limited.

1. A process for manufacturing shrimp feed pellets with a bulk density of at least 550 g/l and a particle diameter of 0.25-5 mm, comprising:
(a) providing a biomass product with a water content of at most 10 wt. % (calculated on the biomass product) and a DHA content of at least 20 wt. % (calculated on the biomass product), the biomass product being derived from microorganisms of the family Thraustochytriaceae or the family Cryptecondiniaceae,
(b) preparing a mixture comprising 0.1-10 wt. % (calculated on dry weight of the shrimp feed pellet) of the biomass and the balance further feed components, and
(c) subjecting the mixture thus obtained to a pellet pressing to form shrimp feed pellets with a bulk density of at least 550 g/l and a particle diameter of 0.25-5 mm.

2. The process according to claim 1, wherein the biomass product is derived from Schizochytrium limacinum or Aurantiochytrium limacinum.

3. The process according to claim 1, wherein the water content of the biomass product is less than 8 wt. %.

4. The process according to claim 1, wherein the water content of the biomass product is less than 2 wt. %.

5. The process according to claim 1, wherein the biomass product comprises at least 25 wt. % DHA calculated on the dry biomass weight.

6. The process according to claim 1, wherein the biomass product comprises between 25 wt. % and 45 wt. % DHA calculated on the dry biomass weight.

7. The process according to claim 1, wherein the shrimp feed pellets have a biomass content of at least 0.3 wt. %.

8. The process according to claim 1, wherein the shrimp feed pellets have a biomass content in the range of 0.5-2 wt. %.

9. The process according to claim 1, wherein the shrimp feed pellets comprise the following, calculated on dry weight of the pellets:
protein, in an amount of 30-50 wt. %
carbohydrates, in an amount of 5-40 wt. %
lipids, in an amount of 5-15 wt. %
ash, in an amount of 3-15 wt. %.

10. Pellet-pressed shrimp feed pellets with a bulk density of at least 550 g/l and a particle diameter of 0.25-5 mm, comprising 0.1-10 wt. % (calculated on dry weight of the shrimp feed pellet) of biomass product with a water content of at most 10 wt. % (calculated on the biomass) and a DHA content of at least 20 wt. % (calculated on the biomass), the biomass being derived from microorganisms of the family Thraustochytriaceae or the family Cryptecondiniaceae.

11. The pellet-pressed shrimp feed pellets according to claim 10, which have a bulk density of at least 600 g/l.

12. The pellet-pressed shrimp feed pellets according to claim 10, which have a bulk densityin the range of 650-800 g/liter.

13. The pellet-pressed shrimp feed pellets according to claim 10, which are cylinders, spheres, tablets, or rods, with the pellets having a height to diameter range of 1:5 to 5:1.

14. The pellet-pressed shrimp feed pellets according to claim 13, having a height to diameter range 1:3 to 3:1.

15. The pellet-pressed shrimp feed pellets according to claim 10, wherein ratio between the DHA content in a sample taken from the core of the pellet and the DHA content in a sample taken from the outer layer of the pellet is between 0.8:1 and 1:0.8.

16. The pellet-pressed shrimp feed pellets according to claim 15, wherein the ratio is between 0.9:1 and 1:0.9.

17. The pellet-pressed shrimp feed pellets according to claim 10, which have a pellet durability index of at least 80%.

18. The pellet-pressed shrimp feed pellets according to claim 10, which have a pellet durability index of at least 90%.

19. A process for growing shrimp, comprising feeding the shrimp for at least some of their lifetime shrimp feed pellets according to claim 7.
